(19) United States
(12) Patent Application Publication
(10) Pub. No.: US 2019/0130071 A1
(43) Pub. Date: May 2, 2019

(54) HEALTH CARE SYSTEM FOR PHYSICIANS TO MANAGE THEIR PATIENTS

(71) Applicant: HDK Investments, LLC, Sugar Land, TX (US)

(72) Inventor: Chetan Chatwani, Houston, TX (US)

(21) Appl. No.: 15/799,454

(22) Filed: Oct. 31, 2017

(51) Int. Cl. G06F 19/00

(52) U.S. Cl. CPC G06F 19/324; G06F 19/322; G06Q 10/06393; G06F 19/3406; G06F 19/366

(57) ABSTRACT

The present invention discloses about a web based portal developed for physician's clinical research & related clinic operations workflow management. The web based portal is a software application that offers the capability to integrate with pharmacy order processing systems, which helps to keep track of patient prescription history in an automated environment. For specifically selected patients, the application extracts pharmacy ordering data from order processing systems and attaches this same data to the electronic patient medical profile. This greatly assists the physician in knowing the status of the patient's prescription history at any given point in time. Further the application offers the capability to integrate with related lab test results using HL7 interface system which helps in creating a comprehensive laboratory test results environment to patient medical profile in automated manner. Further the application offers a dashboard to display analyzed patient treatment data in an efficient manner. The application further helps to monitor “Hepatitis C” Patients medical treatment details while also keeping track of HIV co-infected patients.

### FIELD OF THE INVENTION

The present invention relates generally to a method and system for managing and displaying electronic health care records and more particularly the present invention relates to a web based user interface to manage and display electronic health care records of patients to a physician.

### BACKGROUND OF THE INVENTION

Very few people, carry their medical records around with them, further it is also difficult for the physician to remember the status of treatment of each of his patients. Many people have portions of their hardcopy and computer-based medical records scattered throughout different locations, such as their homes, offices, hospitals, and various health care providers' offices. Often, people simply do not know where their medical records are located. Some hospitals keep lab records in electronic form to store patient treatment test records, pharmacy order records which can be accessible to the authorized physicians or other hospital staffs on demand or request raised by the patient. Thus, there is a need for availing the complete medical treatment records of the patient to the physician greatly save time and improve quality of treatment. Further, physicians do not waste time and resources to extract the history of their patients and know the ongoing treatment status, test results, pharmacy records, etc. of their patients.

It is critical that physicians and patients must able to find every treatment records that may be encountered by the patient at any time to provide healthcare providers with a comprehensive and accurate patient history and efficient treatment procedure. Moreover, availing these documents in a systematic way in a dashboard to the physician are critical because medical records or portions thereof frequently get lost and not properly managed and represented to the physician by each and every patient.

In addition, these medical records are critical in cases of malpractice resulting in medical claims and lawsuits. In other words, there exists a long felt need for a medical records are conveniently updated with each medical episode and that can be examined in the event that something goes wrong to determine the root cause(s) of the problem.

There is a long felt need for a method, process, or system that has the capability to play a significant role in revolutionizing the healthcare industry by providing physicians with the capability to have their patient medical data readily accessible in an organized or graphical representation in a dashboard, and in an electronic media so that the data can be used to possibly save the patient's life by providing the medical data to the healthcare professional in a complete, accurate, concise, cost-effective and timely manner and more importantly in a in an organized or graphical representation in a dashboard for effective medical treatment of the patient regardless of location and situation including emergency situations.

Numerous innovations have been provided in prior art that are adapted to system and method for managing and maintaining electronic health care records. Even though these innovations may be suitable for the specific purposes to which they address, however, they would not be as suitable for the purposes of the present invention.

U.S. Patent Application No. 20,170,124,276 to Tee discloses about a mobile application that is used for monitoring and management of various health or disease conditions, medical histories and real-time measurement data for the users or patients that can be organized and shared among various people who are involved in the caring of the patient.

U.S. Patent Application No. 20,140,038,152 to Micieli discloses about a method and system for generating a patient report of a medical consultation by a health care professional using a graphical user interface (GUI) and presenting at least one image and patient data on said GUI to said patient or a third party.

U.S. Pat. No. 8,706,523 to Kulawiec et al. discloses about methods and systems for treatment regimen management for at least hepatitis C and HIV of a patient. The treatment regimen includes multiple treatment events are scheduled in an electronic calendar. The treatment events are based upon the first treatment schedule and the second treatment schedule. A treatment alert associated with each of the treatment events is generated.

U.S. Pat. No. 9,280,685 to Jackson discloses about a system and method for add, store and display medical records in a portable device. The access to the portable electronic medical record can be limited to an individual patient and his/her designated authorized healthcare provider(s).

PCT Patent Application No. WO 2,016,196,023 to Polimeni discloses about a system and method for managing and maintaining electronic health care records on a web based database controlled by the patient where the electronic health care records are updated on the web based database immediately at the point of service.

U.S. Patent Application No. 20,120,101,847 to Johnson et al. discloses about systems, methods for computer readable media performing mobile medical information management of patient identification data and patient treatment data in one or more web-based portals that can be accessed by the patient, physician or other authorized care provider treating or evaluating the patient.

U.S. Patent Application No. 20140358586 to Patel et al. discloses about a method of creating, storing, accessing, presenting health care information by one of the patient and a health care provider on a corresponding computer.

U.S. Pat. No. 9,524,569 to Moore et al. discloses about a computer-implemented method executed using one or more processors, the method comprising, processing, by the one or more processors, patient data to generate one or more graphical representations of the patient data, at least one graphical representation of the one or more graphical representations.

U.S. Pat. No. 9,613,445 to Gilger discloses about a computer implemented method of displaying a virtual patient chart by receiving data relating to a patient and generating a graphic using a processor, wherein the graphic represents at least one attribute related to a characteristic of the patient,

U.S. Patent Application No. 20,170,098,039 to Abergel et al. discloses about a healthcare patient application, which is configured to interface with healthcare provider's electronic medical records (EMR) systems to send/receive to/from healthcare provider's EMR systems patient medical records for transmission to one or more healthcare provider applications and EMR systems.

U.S. Patent Application No. 20,170,098,039 to Abergel et al. discloses about a computer-implemented method comprising, storing electronic patient data for a plurality of patients; analyzing the patient data of a particular patient to generate one or more recommended healthcare actions for the patient; generating by a computer and transmitting to the patient an electronic message including the recommended actions.

It is apparent now that numerous innovations for managing and maintaining electronic health care records or the like have been developed in the prior art that are adequate for various purposes. Furthermore, even though these innovations may be suitable for the specific purposes to which they address, accordingly, they would not be suitable for the purposes of the present invention as heretofore described. Thus, a web based user interface to manage and display electronic health care records of patients to one or more physicians at a time to provide efficient treatment and effective care to the patient at less time while minimizing error in knowing the status of the treatment and patient history is needed.

### SUMMARY OF THE INVENTION

The present invention discloses about a web based portal developed for physician's clinical research and related clinic operations workflow management. The web based portal is a software application that offers the capability to integrate with pharmacy order processing system s, which helps to keep track of patient prescription history in an automated environment. For specifically selected patients, the application extracts pharmacy ordering data from order processing systems and attaches this same data to the electronic patient medical profile. This greatly assists the physician in knowing the status of the patient's prescription history at any given point in time. Further the application offers the capability to integrate with related lab test results using HL7 interface system which helps in creating a comprehensive laboratory test results environment to patient medical profile in automated manner. Further the application offers a dashboard to display analyzed patient treatment data in an efficient manner. The application further helps to monitor “Hepatitis C” Patients medical treatment details while also keeping track of HIV co-infected patients.

According to an aspect of the present invention, a system for managing medical data workflow related to physician's clinical research and related clinical operations, wherein the system comprising, a treatment data system to store patients' medical treatment data, wherein the treatment data system comprises, at least one lab data system to store current laboratory test results data, at least one pharmacy data system to store pharmacy ordering data, and a demographic data system to store patient demographics along with physician details and insurance details; a history data system to store patient's medical history and patient's lab testing history; a suggestion data system to store medical documentation and physician comments; a wireless network; a central server, wherein the central server connects to the treatment data system, the history data system and the suggestion data system through the wireless network; and a web based user interface, wherein the user interface allows the physician to a search interface and customizable reporting capabilities, thereby displaying the requested data in extracted from the central server in a desired format through a dash board.

In view of the foregoing, it is therefore an object of the present invention is to provide a web based user interface for managing medical data workflow related to physician's clinical research and related clinical operations.

Another objective is to provide a web based user interface such as a software application that allows physicians to a quick at-a-glance view capability of KPIs (key performance indicators) relevant to a particular clinical objective or business related process based on the medical data of the patient. Further the key performance indicators report can be displayed in a dashboard in graphical format.

Yet another objective is to provide a web based user interface such as a software application that allows physicians to monitor “Hepatitis C” Patients medical treatment details while also keeping track of HIV co-infected patients.

Yet another objective is to provide a web based user interface such as a software application that allows extracting pharmacy ordering data from at least one pharmacy order processing system and integrate the pharmacy ordering data to the patient medical treatment data to keep track of patient prescription history in an automated environment.

Yet another objective is to provide a web based user interface such as a software application that allows automatic integration of laboratory test results data to patients' medical treatment data using HL7 interface system.

Yet another objective is to provide a web based user interface such as a software application that allows controlled access to one or more users such as several physicians at a time to access or update a predetermined set of medical data of the patient.

Yet another objective is to provide a web based user interface such as a software application that facilitates data analysis and extraction in a required customized report format by using information filters and sharing the extracted data and reports with other system users.

Yet another objective is to provide a method for managing medical data workflow related to physician's clinical research and related clinical operations in a web based user interface, wherein the medical data comprising patients' medical treatment data, current laboratory test results data, pharmacy ordering data, patient demographics along with physician details and insurance details, patient's medical history, patient's lab testing history, medical documentation and physician comments.

Other objectives and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 illustrates block diagram of a system for managing medical data workflow related to physician's clinical research and related clinical operations in a web based user interface, in accordance with an embodiment of the present invention; and

FIG. 2 illustrates a flow chart for a method for managing medical data workflow related to physician's clinical research and related clinical operations in a web based user interface, in accordance with an embodiment of the present invention.

Like reference numerals refer to like parts throughout the various views of the drawings.

### DETAILED DESCRIPTION OF THE INVENTION

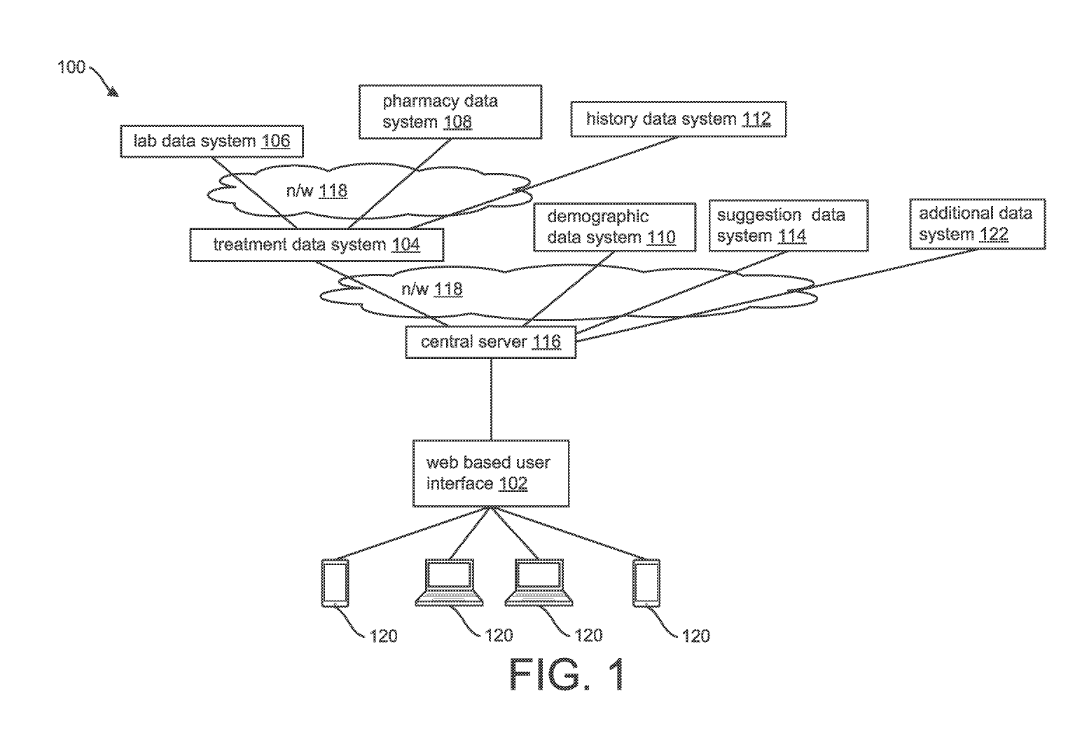

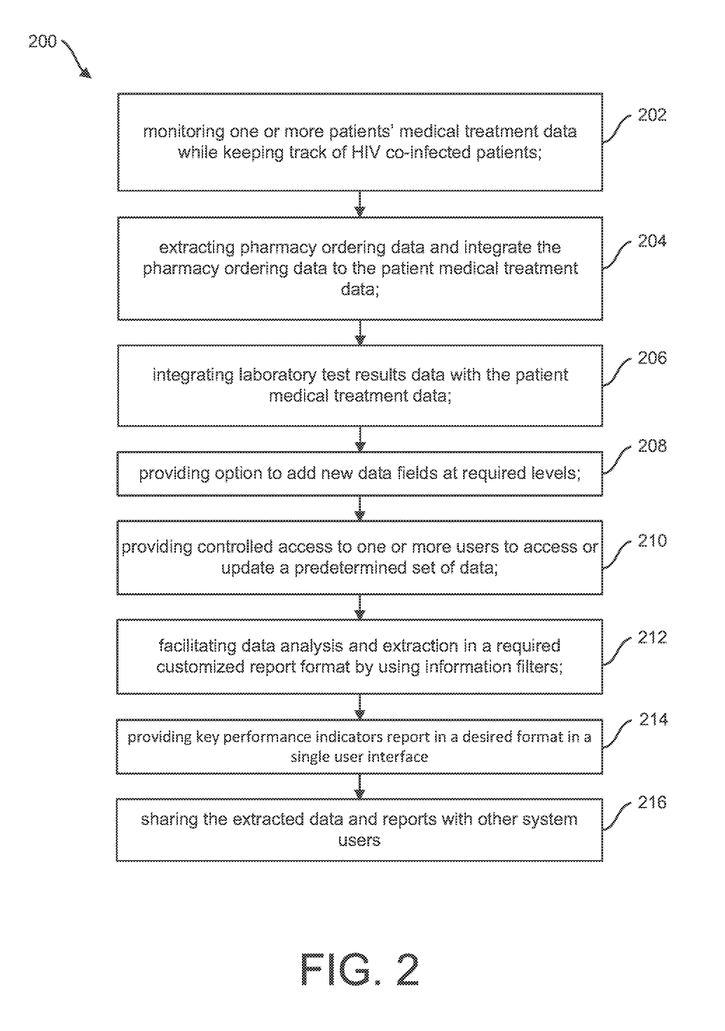

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, as oriented in FIG. 1-2, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims and are therefore not to be considered as limiting, unless the claims expressly state otherwise.

The present invention provides a method 200 and system 100 for managing and displaying electronic health care records and more particularly the present invention relates to a web based user interface 102 to manage and display electronic health care records of patients to a physician as referenced in FIGS. 1 and 2. The user interface 102 is a software application that offers the capability to integrate with pharmacy order processing system 108, which helps to keep track of patient prescription history in an automated environment. For specifically selected patients, the application extracts pharmacy ordering data from pharmacy data system 108 and attaches this same data to the electronic patient medical profile. This greatly assists the physician in knowing the status of the patient's prescription history at any given point in time. Further the application offers the capability to integrate with related lab test results from a lab data system 106 using HL7 interface system which helps in creating a comprehensive laboratory test results environment to patient medical profile stored in treatment data system 104 in automated manner. Further the application offers a dashboard to display analyzed patient treatment data in an efficient manner in a portable/personal device 120. The application 102 further helps to monitor “Hepatitis C” Patients medical treatment details while also keeping track of HIV co-infected patients.

According to one aspect of the present invention a method 200 for managing medical data workflow related to physician's clinical research and related clinical operations in a web based user interface 102, wherein the method 200 comprising, step 202 of monitoring one or more patients' medical treatment data while keeping track of HIV co-infected patients; step 204 of extracting pharmacy ordering data and integrate the pharmacy ordering data to the patient medical treatment data; step 206 of integrating laboratory test results data with the patient medical treatment data; step 208 of providing option to add new data fields at required levels; step 210 of providing controlled access to one or more users to access or update a predetermined set of data; step 212 of facilitating data analysis and extraction in a required customized report format by using information filters; step 214 of providing key performance indicators report in a desired format in a single user interface; and step 216 of sharing the extracted data and reports with other system users.

According to another aspect of the present invention, the laboratory test results data are integrated automatically to patients' medical treatment data using HL7 interface system.

According to another aspect of the present invention, the pharmacy ordering data is extracted from at least one pharmacy data system 108, which helps to keep track of patient prescription history in an automated environment.

According to another aspect of the present invention, the information filters are custom filters set by the one or more user, wherein the custom filters can be reused whenever needed as well as shared with all other users.

According to another aspect of the present invention, the data extracted is protected from being manipulated.

According to another aspect of the present invention, the key performance indicators report is displayed in a dashboard in graphical format.

According to another aspect of the present invention, the patients' medical treatment data, the laboratory test results data and the pharmacy ordering data are stored in a centralized database also referred as central server 116.

According to another aspect of the present invention, a method 200 for managing medical data workflow related to physician's clinical research and related clinical operations in a web based user interface 102, wherein the medical data comprising patients' medical treatment data, current laboratory test results data, pharmacy ordering data, patient demographics along with physician details and insurance details, patient's medical history, patient's lab testing history, medical documentation and physician comments.

In an embodiment of the present invention as referenced in FIG. 1, the system 100 comprises a web based user interface 102 for managing medical data workflow related to physician's clinical research and related clinical operations, wherein the medical data comprising patients' medical treatment data from a treatment data system 104, current laboratory test results data from a lab data system 106, pharmacy ordering data from a pharmacy data system 108, patient demographics along with physician details and insurance details from a demographic data system 110, patient's medical history and patient's lab testing history from a history data system 112, medical documentation and physician comments from a suggestion data system 114 are connected through wireless network 118 to a central server 116. The central server 116 allows the requested data to be represented in user interface 102 in a desired format such as graphical format to the physician on his personal electronic device 120 such as computer, laptop or on mobile devices including a mobile phone, tablets.

The system 100 offers the capability to integrate with pharmacy data system 108 which helps to keep track of patient prescription history in an automated environment. For specifically selected patients, the application extracts pharmacy ordering data from the pharmacy data system 108 and attaches this same data to the electronic patient medical profile or treatment data system 104. This greatly assists the physician in knowing the status of the patient's prescription history at any given point in time. Further the system 100 offers the capability to integrate with related laboratory test results using HL7 interface system which helps in creating a comprehensive laboratory test results environment to patient medical profile in automated manner.

The system 100 has robust and customizable reporting capabilities that facilitates in creating commonly used information filters and share it with other system users. The custom filter makes defining the search criteria easy and once established on a per-user basis it can easily be reused whenever needed as well as shared with all other users.

The web based user interface 102 is a software application that facilitates data analysis and extraction of data in a required customized report format by using information filters and sharing the extracted data and reports with other system users. The application 102 further offers a dashboard to display analyzed patient treatment data in an efficient manner, thereby allowing physicians to routinely display a quick at-a-glance view capability of key performance indicators relevant to a particular clinical objective or business related process for example research, productivity, marketing, human resources, or business performance or the like based on the medical data of the patient. Further the key performance indicators report can be displayed in a dashboard in graphical format.

The application 102 of the system 100 offers a feature that controls permission profiles at a very granular level that helps in appropriately controlling the access for given user. The application 102 can also assign set of required physicians and medical practitioner to allow them to view or update only specific data.

The application 102 of the system 100 provides access to backend database information 104, 116 which makes it easy for other software to extract data when needed or granted. The access is provided as read only thus protecting the integrity of the data extracted.

The application 102 of the system 100 is easily customized by adding new data fields from an additional data system 122 at required levels which helps in monitoring additional clinical data for research & business workflow management.

The application 102 of the system 100 facilitates easy data extraction in a required format which would be imported into other software.

In another embodiment of the present invention as referenced in FIG. 2, the method 200 for managing medical data workflow related to physician's clinical research and related clinical operations in a web based user interface, wherein the method comprising, step 202 of monitoring one or more patients' medical treatment data while keeping track of HIV co-infected patients; step 204 of extracting pharmacy ordering data and integrate the pharmacy ordering data to the patient medical treatment data that greatly assists the physician in knowing the status of the patient's prescription history at any given point in time; step 206 of integrating laboratory test results data with the patient medical treatment data by using HL7 interface system, which helps in creating a comprehensive laboratory test results environment to patient medical profile in automated manner; step 208 of providing option to add new data fields at required levels; step 210 of providing controlled access to one or more users to access or update a predetermined set of data, further the step 210 assign set of required physicians and medical practitioner to allow them to view or update only specific data; step 212 of facilitating data analysis and extraction in a required customized report format by using custom information filters, whereby the custom filter makes defining the search criteria easy and once established on a per-user basis it can easily be reused whenever needed as well as shared with all other users; step 214 of providing key performance indicators report in a desired format, for example in a graphical format in a single user interface; and step 216 of sharing the extracted data and reports with other system users for example co-physicians, patients, or relatives of patients.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A system for managing medical data workflow related to physician's clinical research and related clinical operations, wherein the system comprising:
a treatment data system to store patients' medical treatment data, wherein the treatment data system comprises,
at least one lab data system to store current laboratory test results data,
at least one pharmacy data system to store pharmacy ordering data, and
a demographic data system to store patient demographics along with physician details and insurance details;
a history data system to store patient's medical history and patient's lab testing history;
a suggestion data system to store medical documentation and physician comments;
a wireless network;
a central server, wherein the central server connects to the treatment data system, the history data system and the suggestion data system through the wireless network; and
a web based user interface, wherein the user interface allows the physician to a search interface and customizable reporting capabilities, thereby displaying the requested data in extracted from the central server in a desired format through a dash board.

2. According to the system of claim 1, wherein the web based user interface is a software application allowing the physician to manage medical data workflow on his personal portable electronic devices.

3. According to the system of claim 1, wherein the laboratory test results data are integrated automatically to patients' medical treatment data using HL7 interface system.

4. According to the system of claim 1, wherein the data extracted from the central server is protected from being manipulated.

5. According to the system of claim 1, wherein the search interface further comprises custom information filters set by the one or more user, wherein the custom filters can be reused whenever needed as well as shared with all other users.

6. A method for managing medical data workflow related to physician's clinical research and related clinical operations in a web based user interface, wherein the method comprising:
monitoring one or more patients' medical treatment data while keeping track of HIV co-infected patients;
extracting pharmacy ordering data and integrate the pharmacy ordering data to the patient medical treatment data;
integrating laboratory test results data with the patient medical treatment data;
providing option to add new data fields at required levels;
providing controlled access to one or more users to access or update a predetermined set of data;
facilitating data analysis and extraction in a required customized report format by using information filters;
providing key performance indicators report in a desired format in a single user interface; and
sharing the extracted data and reports with other system users.

7. According to the method of claim 6, wherein the laboratory test results data are integrated automatically to patients' medical treatment data using HL7 interface system.

8. According to the method of claim 6, wherein the pharmacy ordering data is extracted from at least one pharmacy order processing system, which helps to keep track of patient prescription history in an automated environment.

9. According to the method of claim 6, wherein the data extracted is protected from being manipulated.

10. According to the method of claim 6, wherein the information filters are custom filters set by the one or more user, wherein the custom filters can be reused whenever needed as well as shared with all other users.

11. According to the method of claim 6, wherein the key performance indicators report is displayed in a dashboard in graphical format.

12. According to the method of claim 6, wherein the patients' medical treatment data, the laboratory test results data and the pharmacy ordering data are stored in a centralized database.

13. According to the method of claim 6, wherein the medical data further includes:
patient demographics along with physician details and insurance details;
patient's medical history;
patient's lab testing history;
medical documentation; and
physician comments.
